(19) United States
(12) Patent Application Publication
(10) Pub. No.: US 2016/0212487 A1
(43) Pub. Date: Jul. 21, 2016

(54) METHOD AND SYSTEM FOR CREATING SEAMLESS NARRATED VIDEOS USING REAL TIME STREAMING MEDIA

(71) Applicant: Srinivas RAO, San Diego, CA (US)

(72) Inventor: Srinivas RAO, San Diego, CA (US)

(21) Appl. No.: 15/001,205

(22) Filed: Jan. 19, 2016

Related U.S. Application Data
(60) Provisional application No. 62/105,147, filed on Jan. 19, 2015.

(51) Int. Cl. H04N 21/472; H04N 21/4782; G06F 3/0484; G06F 3/0485; H04L 29/06; G06F 3/0482

(52) U.S. Cl. CPC H04N 21/47205; H04L 65/60; G06F 3/0482; G06F 3/04842; G06F 3/04847; G06F 3/0485; H04N 21/47217; H04N 21/4782

(57) ABSTRACT

A computer-implemented method and system for creating a streaming media compilation having time-synchronized annotations. The computer-implemented method includes accessing streaming media from one or more external sources through a browser user interface. Further, the computer-implemented method includes passing a particular Nr8 to two entities to a requesting browser and tagging and annotating the streaming media. Furthermore, the computer-implemented method includes mapping the annotations to a master time-line thereby providing a single seamless video experience of one single media presentation wherein the user performs a desired action, the action includes one of play, pause, seek and scroll. Moreover, the computer-implemented method includes displaying a top panel and a bottom panel to a user through a Nr8 user interface.

### TECHNICAL FIELD

Embodiments of the disclosure relate generally to on-line media presentations. Embodiments relate more particularly to a method and system for creating a new type of video experience using on-line streaming media.

### BACKGROUND

It is well known in the media arts that users may upload or watch video content on the Internet. An example of this technology are the streaming services such as YouTube/Vimeo platforms, which embed a media player in a web-page that allows users on the Internet to view or watch said video. The content inside is ‘streamed’ directly from the servers of the respective media streaming service. As a secondary offering, the above streaming services also provide API services. These API services allow other web-sites, platforms, mobile applications, media companies and blogs to embed any authorized video from the host streaming services into their own pages. This technology is used by well establish media companies such as nytimes.com, huffingtonpost.com, wordpress.com and upworthy.com etc., that use and embed youtube and Vimeo videos on their pages. In fact, upworthy.com, which has been the fastest growing media company in the world, is solely based on the concept of embedding videos from YouTube which are repackaged with relevant titles and description.

The above mentioned companies use the most basic technique of embedding a video, which in essence plays one video, either from Youtube or Vimeo, from start to finish. However, a need exists for using the advanced API's (Application Programmer Interfaces) that are provided by both youtube.com and vimeo.com for providing users with a more robust user experience, where the user may not want to embed the whole source video but desires to embed only a portion of the video. These advanced API's may be used to summon specific media resources and request streaming at specific times and stop streaming at specific times within the stream.

The user may also want to splice together different portions of different source videos, either from the same hosing services or different hosting services. The user may desire to insert his own images or texts to be able to make the video experience much more effective for his audience. Lastly, the user may also want to add his own annotations that are displayed at specific desired parts of this video compilation.

Also, it would be desirable to provide a custom user control bar which hides the default control bars for the embedded player provided by the above mentioned services. Additionally, it would be desirable to have the audience of the said video created by the said user, be unaware of when certain resource stops streaming and a different one begins streaming providing the audience with a single seamless video experience. The whole video, that is comprised of portions of various source videos along with the images, text and annotations would need to play seamlessly so that the audience are able to enjoy it as one single integrated video experience. The present invention solves these problems in a unique and novel fashion over the prior art.

In the light of the above discussion, there appears to be a need for providing a new type of video experience using on-line streaming media.

### OBJECT OF INVENTION

The principal object of the embodiments herein is to provide a method and system for creating a mash-up from a number of streaming media content including textual and image annotations which may accompany the streaming media.

Another object of the embodiments herein is to provide streaming and annotations that are mapped to a “master time-line” creating a seamless user experience of one single media presentation wherein the user may play, pause, seek, scroll video and related annotations back and forth.

Another object of the embodiments herein is to store references to external sources from where the media is streamed in addition to the specific times within a time-line of the stream for when the streaming should begin and end. The original media itself is not replicated but rather they stream directly from respective host streaming services based on the references stored and respective API services offered by the streaming services.

### SUMMARY

The above-mentioned needs are met by a computer-implemented method, computer program product and system for creating seamless narrated videos using real time streaming media. This computer program product, that offers services based on this invention would henceforth in this patent application be referred to as ‘NR8’ (pronounced as ‘narrate’). Also an individual video compilation (comprising of different media source streams, images, text and annotations) as described in the above sections would henceforth in this patent application be referred to as a ‘nr8’ (pronounced as ‘narrate’).

An example of a system for creating a streaming media compilation having time-synchronized annotations includes a computing device configured with a media player to play videos that are streamed from one or more external servers. The system also includes a web browser configured within the computing device to display desired web pages. Further, the system includes a web server for streaming media and nr8 playback and a network to connect the computing device to a web browser. Furthermore, the system includes a processing module configured within the web server and operable to perform: access streaming media from one or more external sources through a browser user interface; pass two entities, a set of rules and a nr8 engine, which are necessary to play the requested nr8 to a requesting browser; tag and annotating the streaming media; map the annotations to a master time-line thereby providing a single seamless video experience of one single media presentation wherein the user performs a desired action, the action includes one of play, pause, seek and scroll; and display a top panel and a bottom panel to a user through a Nr8 user interface. Moreover, the computer-implemented method includes displaying a top panel and a bottom panel to a user through a Nr8 user interface, top panel is where the media steam is played along with the images and text whereas the bottom panel is the one where the time synchronized annotations are displayed.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of the environment in accordance with the present invention;

FIG. 2 depicts a high-level view of the NR8 platform and how it fits in the larger eco-system.

FIG. 3 is a system block diagram illustrating how a nr8 plays inside a browser;

FIG. 4 is a timeline chart illustrating an example of one method for meshing real time streaming media at start and stop locations using reference times in accordance with the present invention;

FIG. 5 is a flowchart that illustrates how one process of playing a media experience based on a set of time-synchronized reference locations in accordance with the present invention;

FIG. 6 is a block diagram that illustrates how a NR8 player pre-loads and pre-buffers

YouTube and/or Vimeo players to allow a seamless playback.

FIG. 7 is a block diagram that illustrates a nr8 is composed based on a procedure that looks like video editing although there are fundamental differences between a traditional video editing and video editing in the context of this invention;

FIG. 8 is a block diagram illustrating how an embodiment of this invention can be used for fine grained indexing of video data. This finer indexing results in people looking for a certain text through search are presented with all the relevant where they can pre-view snippets pertaining to their queries right in the search listing page.

FIG. 9 is a block diagram illustrating how based on a search result and user clicking on particular matching annotation with one specific search result, the user is brought to a specific point in time of the nr8 video which has relevance to the text which the user is searching for;

FIG. 10 is a block diagram illustrating the NR8 platform's API service offerings and also how other web-sites, media companies can embed a nr8 video in their own pages using our API services;

FIG. 11 illustrates how when an nr8 video is embedded in a nr8 page or an external host (using NR8 API services), NR8 player in turn embed a number of other necessary players which are hidden and unhidden as needed during a playback; and

FIG. 12 illustrates how with the present invention, multiple players can be placed side-by-side and played in a synchronized manner.

FIG. 13 is a block diagram of a machine in the example form of a computer system within which instructions for causing the machine to perform any one or more of the methodologies discussed herein may be executed.

### DETAILED DESCRIPTION OF THE EMBODIMENTS

The above-mentioned needs are met by a method and system for producing or creating a streaming media compilation having time-synchronized annotations. The following detailed description is intended to provide example implementations to one of ordinary skill in the art, and is not intended to limit the invention to the explicit disclosure, as one or ordinary skill in the art will understand that variations can be substituted that are within the scope of the invention as described.

Specifically, the present invention describes a video editing, splicing based streaming media, web annotation and tagging software tool. The software tool is herein referred to as a “NR8”. Web annotation is an online annotation associated with a web resource, typically a web page. Typically, annotation is a metadata (for instance, a comment or an explanation) that is attached to text, image or other data. Further, web annotation allows a user to add, modify or remove information from the web resource without actually modifying the resource itself.

### Environment Block Diagram

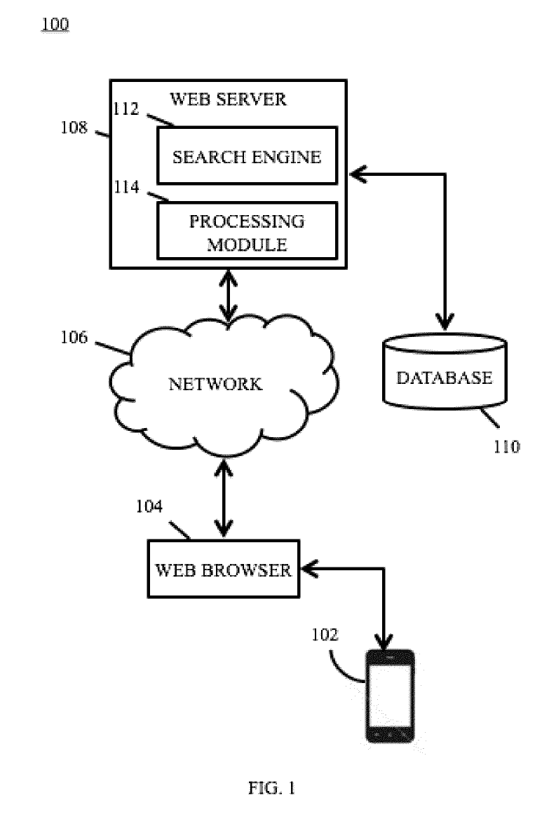

FIG. 1 is a block diagram of the environment, according to the embodiments as disclosed herein. The environment 100 includes a computing device 102, a web browser 104, a network 106, a web server 108 and a database 110. The web server 108 includes a search engine 112 and a processing module 114.

The computing device 102 is operated by a user who desires to splice, tag and annotate streaming media. Examples of the computing device include, but are not limited to, a personal computer (PC), laptops, a mobile phone, a tablet device, a personal digital assistant (PDA), a smart phone and a laptop.

Typically, the web browser 104 is configured within the computing device 102. Typically, the web browser 104 is a software application for retrieving, presenting and traversing information resources (such as, web pages, images and videos) on the World Wide Web. Examples of the web browser 104 include, but are not limited to, Firefox, Internet Explorer, Google Chrome, Opera and Safari.

The web server 108 is an application that processes requests on the World Wide Web (www). The primary function of the web server 108 is to store, process and deliver web pages.

The database 110 stores composed video compilations also referred to as nr8's.

The search engine 112 allows a search feature that allows the user to search for desired text key words, resulting in specific annotation pages of the matching video compilations or nr8's.

The processing module 114 is configured with a non-transitory computer-readable medium, the contents of which cause the web server 108 to perform the method disclosed herein.

It should be appreciated by those of ordinary skill in the art that FIG. 1 depicts the web server 108 in an oversimplified manner, and a practical embodiment may include additional components and suitably configured processing logic to support known or conventional operating features that are not described in detail herein.

### Block Diagram of Using Nr8 Software

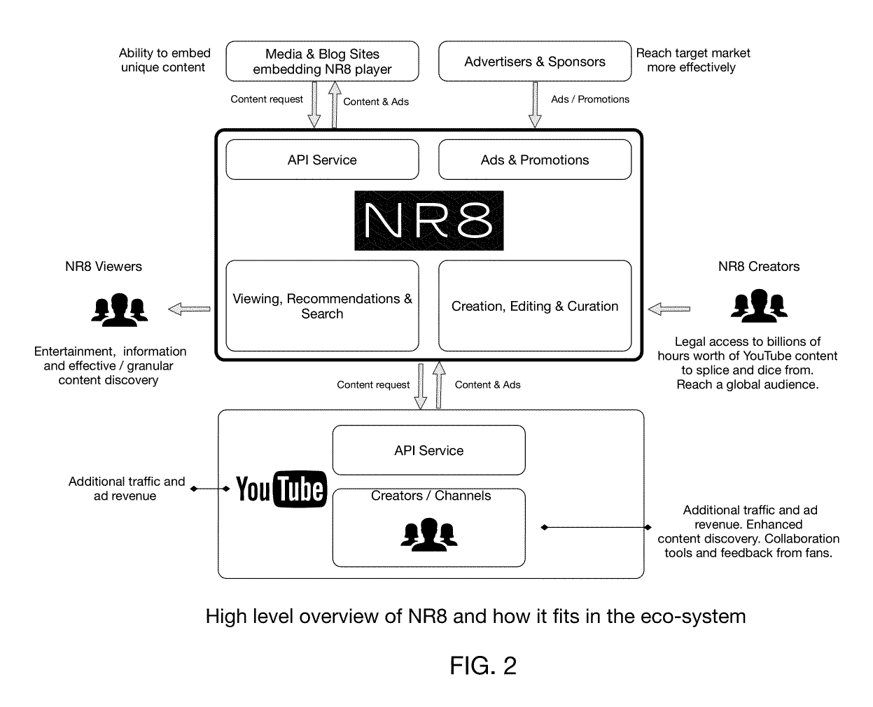

Referring now to FIG. 2, there is show a block diagram which depicts how the NR8 product offering as described in the present invention fits in the larger eco-system. At the bottom it can be seen that API services from streaming services such as YouTube, Vimeo and Facebook are used allowing the nr8 creators to make a streaming mashup known as nr8. This nr8 can be viewed by the audience users. Additionally, NR8 platform as described in this invention also allows other media companies and web-sites to embed a particular video compilation known as nr8 in their own pages.

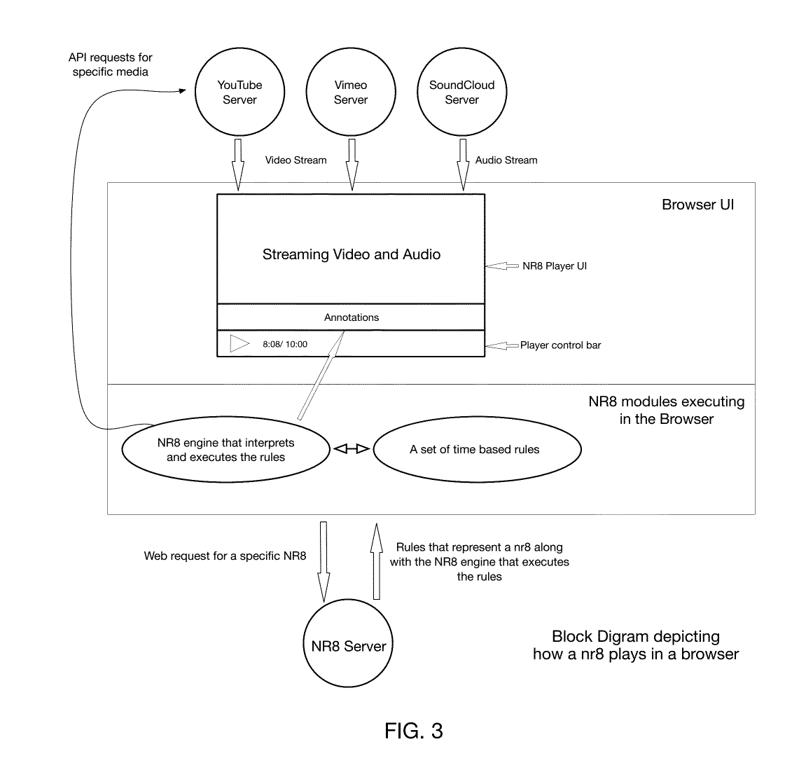

Referring now to FIG. 3, there is shown a system block diagram illustrating an example of process of how Nr8 software works within a browser to seamlessly play a streaming video experience called nr8. It should be noted that all user created annotations are stored in a local server but only references to external media resource identifiers wherein the start and end times within the media stream are stored along with a mapping to a master time-line in accordance the Nr8 software.

Turning once again to FIG. 3, when a user requests a particular Nr8 to be loaded through his web browser on the Nr8.com page, The Nr8 server fetches the particular Nr8 and passes two entities to the requesting browser. More specifically, a set of time-based rules that essentially constitute the Nr8 and a Nr8 engine that captures user interactions with the UI and carries out the set of rules to provide a the user with a Nr8 experience.

As can be seen in the block diagram of FIG. 3, the streaming media itself is accessed from respective servers offering streaming media such as youtube, Vimeo, Sound-Cloud or any similar service which provides API access to their streaming services by way of example. In operation, once the NR8 server hands over the NR8 rules and the NR8 engine to the user's browser, all the actions needed to play the NR8 are carried out fully on the user's browser without any further interaction with the NR8 server.

More specifically, a NR8 user interface typically will show the user a top panel and a bottom panel wherein the top panel contains the embedded streaming video, user loaded images and user uploaded text (text that appears in between videos) and the bottom panel contains annotation text as well as annotation images that are time-synchronized with the top panel. It should be understood that while the video contents of the top panel are directly streamed from external services such as for example YouTube and Vimeo, the texts and images used in text segments and annotations are stored locally on the NR8 server and are made available to the web-browser during a NR8 playback.

In accordance with the present invention the difference between Nr8 and other media annotation and tagging inventions are as follows:

With NR8 platform, the tags/annotations and the underlying media are not stored together. The media streams directly from streaming services.

The media sources themselves are unaware of the tagging/annotations.

The tagging itself is not associated the media key-frames but merely are associated with the nr8 video's master time-line.

The tags created by various nr8 composers are NOT consolidated and they live on their independent existence.

In another preferred embodiment, since the tags/annotations are separate from the underlying media, each media source could potentially be used in an unlimited number of Nr8's. This is envisioned for cases of popular media streams where different nr8's might simultaneously exist where the same media is, say, translated to different languages or some of these popular media streams may be annotated with a spectrum of differing opinions as the nr8 composer sees fit.

The concept of having a youtube/Vimeo in a web page is called embedding a media player. The content inside is ‘streamed’ directly from the servers of youtube, Vimeo and/or other media streaming services using the same type of functionality. A lot of well-established media companies such as for example the nytimes.com, huffingtonpost.com, wordpress.com and upworthy.com etc., embed youtube and Vimeo vidoes on their pages. In fact, upworthy.com, which has been the fastest growing media company in the world, is solely based on the concept of embedding videos in a page with some description and catchy title.

It is well known that the aforementioned companies use the most basic technique of embedding a video. More specifically, playing a single or one video (either from youtube or Vimeo) from start to finish as an example. However, in case of NR8 which is the present invention, it uses advanced API's (Application Programmer Interfaces) that are provided by both youtube.com and vimeo.com. These advanced API's are used to summon specific media resources and allow a streaming request to start at specific times and stop streaming at specific times within the stream. The present invention, also provides custom user control bars which hide the default control bars for the embedded player provided by the above mentioned services. It should be understood that the user is unaware of when certain resource stops streaming and a different one begins streaming as he/she experiences nr8 functionality as a single seamless video experience in accordance with a preferred embodiment.

### NR8 Rules Representation

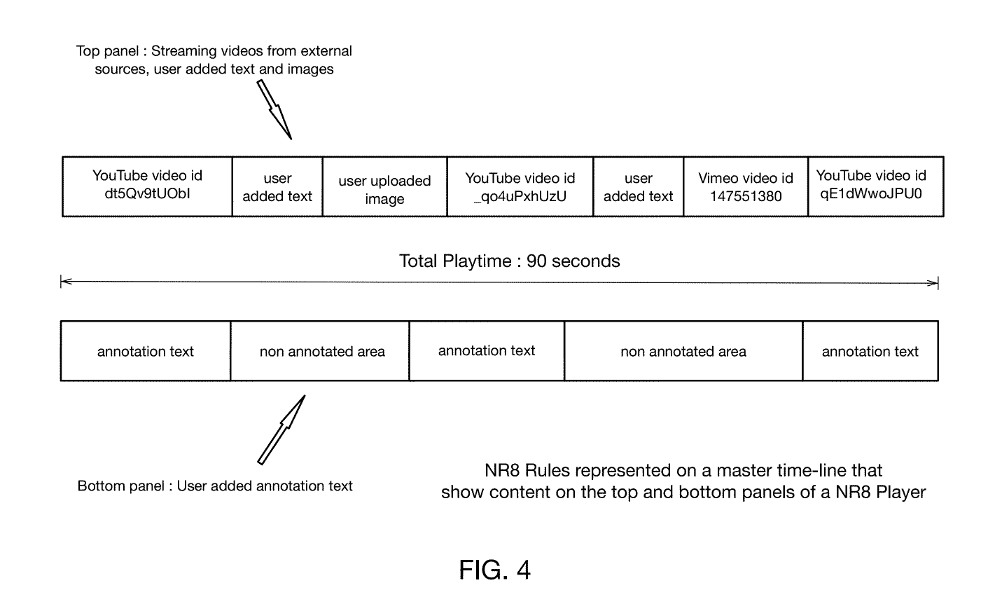

Referring now to FIG. 4, the nr8 rules in accordance with the present invention are represented on a time-line in FIG. 4. NR8 rules, depicted in FIG. 3, is one of the two entities that are passed on to the browser, when the browser makes a request for a particular nr8. More specifically, the nr8 rules are a set of time-based rules that specify exactly when a streaming of a certain media resource should begin and when it should end. It contains the media resource ids and services where the media is streamed from. The nr8 rules also contain any associated text used in text segments (text that appear in between the video to convey certain message(s)). Furthermore, the nr8 rules also contain text and local addresses to any images that are used in annotations.

Since a nr8 may have a top panel (streaming audio/video) as well as bottom panel (annotations) as illustrated in FIG. 3, the Nr8 rules contains the information that is necessary to represent both of these panels.

### Representation of Top Panel and Bottom Panels

Turning once again to FIG. 4, the top rectangle represents the top panel (streaming audio/video) and bottom one (annotations) represents the bottom panel. They share the same master time-line as they are synchronized in time. Lastly, the Nr8 rules depend upon an Nr8 engine for their interpretation and execution.

### Block Diagram of Nr8 Engine Flowchart

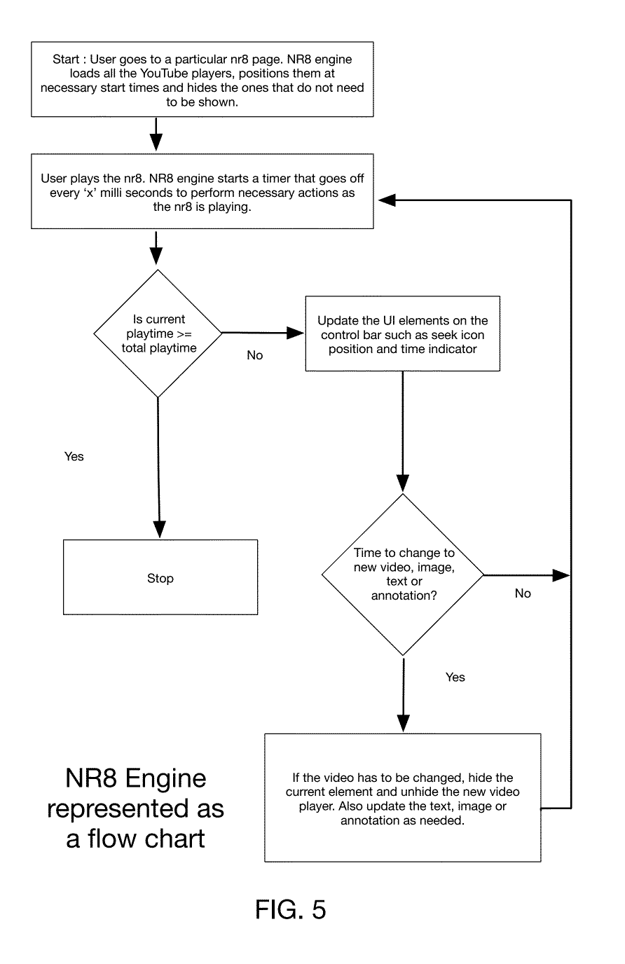

Referring now to FIG. 5, the NR8 engine is one of two entities that are passed on to the web-browser upon the browser requesting a nr8. The NR8 engine is a set of software modules, services and algorithms that in effect, interpret and execute the nr8 rules. The outcome is ‘playing’ of nr8. NR8 engine also listens to user actions and inputs through the UI and responds appropriately while playing a nr8. Turning once again to FIG. 5, the NR8 engine uses a repetitive timer typically of the order of 100 milli-seconds to wake up at each interval and update the timer and player control bar elements (such as icon showing the player progress). These intervals also look for specific actions to be carried out as specified by and in accordance with the nr8 rules. These actions could be starting/stopping a certain stream from external services, changing to a new stream from external services and also displaying text segments and annotation texts/images inside the nr8 player user interface.

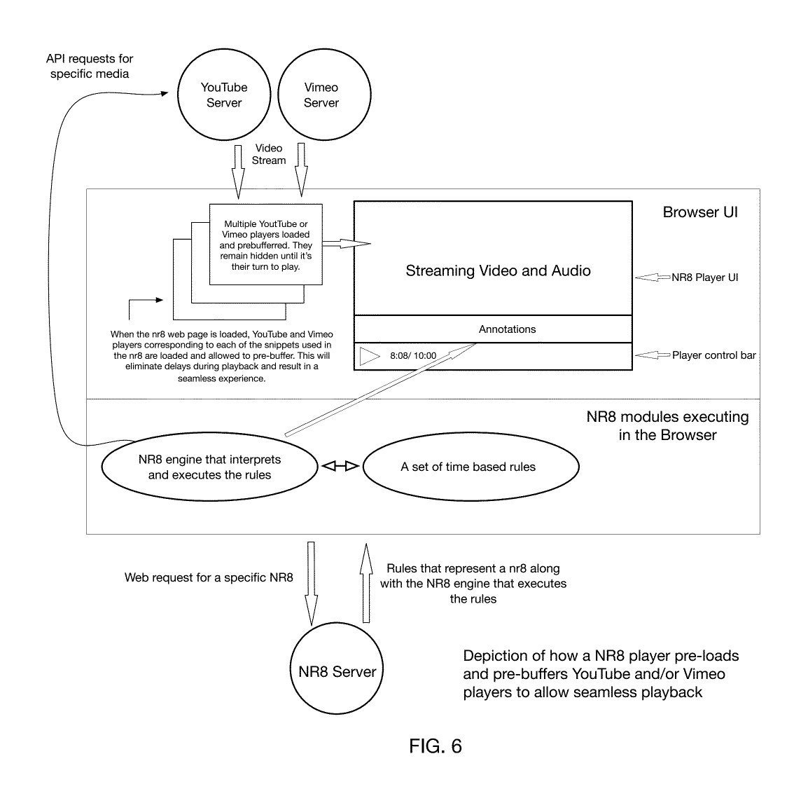

Referring now to FIG. 6, the NR8 player pre-buffers multiple video streams simultaneously in order to provide a seamless transition from one video stream to another. Let us assume now that the user intends to watch a nr8 by going to a web page dedicated for this particular nr8. Let us also assume that this nr8 is comprised of certain portions of 5 different YouTube videos spliced together. Upon loading of the above nr8 page, NR8 player simultaneously loads 5 different YouTube players with each one set to their respective start-times in the nr8 master timeline. This will enable the players to start buffering at these start-times. All these players are hidden so that they are invisible to the user except for the one, if any, that the user may need to see at that point.

As described in the above section as to how number players are simultaneously pre-loaded and allowed to pre-buffer, when the user clicks play, the necessary player is made visible and played. When it is time to transition to the next player, the NR8 player simply hides the current player and unhides the next one. This will have the effect of completely seamless transition with no interruption that would be associated with loading a new player and also buffering. The result is remarkably seamless, uninterrupted video experience that the user can enjoy.

### nr8 Composition

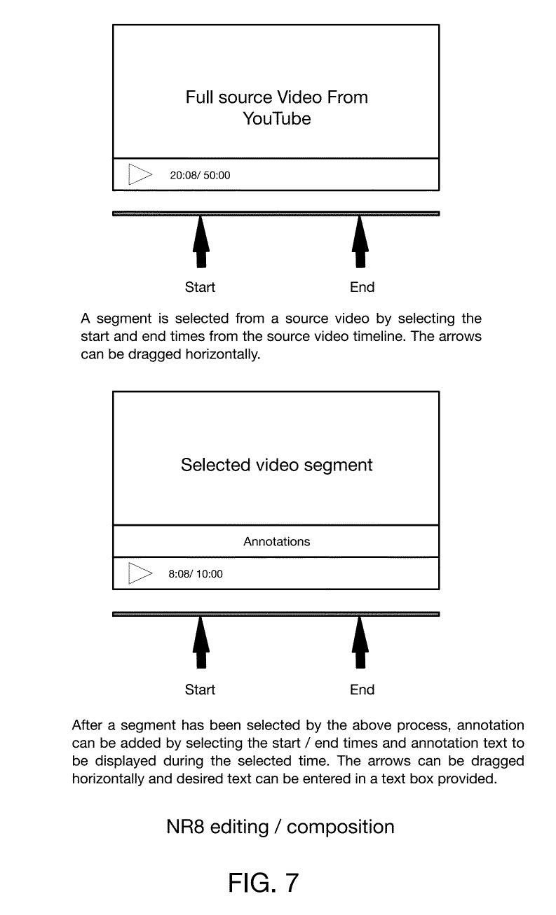

Referring now to FIG. 7, in accordance with another preferred embodiment of the present invention allows for composing a nr8, where the composition experience is similar to a standard ‘video editing’ experience, with the primary difference being that the individual source clips are not locally stored on the local machine or on the cloud account that belongs to the composer. The ‘source clips’ are external media streams that are embedded on the Nr8 composition page. And composition involves using the UI controls to select specific times within the stream to be a part of the nr8. The composition also involves allowing user to enter ‘annotation’ text and images with UI controls that indicate the specific times in the media stream that these annotations should be synchronized with.

Therefore, any registered user of NR8 service may create a ‘narrative’ or a ‘nr8 experience’ using the ‘nr8 composition’ user interface as shown and illustrated in FIG. 7. Using this user interface, the user provides the source media from an external service such as Youtube, Vimeo and sound-cloud. Upon this input from the user, the user interface provides a player with the above media embedded which the composer can then playback. The composer can use this playback to determine which parts of this media stream he would like to use in his/her nr8. He then uses the ‘start segment’ and ‘end segment’ arrows to specify where he wants the streaming to begin and end.

Once a certain segment is chosen, this segment will then appear as an embedded media player so that the composer can add annotations. The user interface provides ‘annotation start’ and ‘annotation end’ arrows to specify specific portions of the segment that the composer can choose to annotate. This UI provides a text-box and a mechanism to upload an image to provide annotation text and images. At any point in time during the nr8 composition, the composer has the ability to play the nr8 that has been composed thus far, from start to finish, using the embedded nr8 on the compose page. This will allow him to review the nr8 as it is being composed and also to preview before ‘submitting’. Once the composer has finished composing the nr8, he will then submit the nr8 to be stored in a database and disseminated to other users of the service who want to watch the nr8.

The original composer (user) can also revisit at a later point in time to edit a previously composed nr8. Composing a nr8 is comparable to a standard ‘video editing’ process. ‘Video editing’ is a common terminology used in standard software such as Apple's Final Cut Pro, Apple's iMovie, Windows Movie Maker, Adobe After Effects, weVideo etc. These software allow a user to make a single video experience using individual video clips. From a user experience stand point composing a nr8 feels very similar to that of traditional ‘video editing’.

However there are very fundamental differences as shown a traditional video editing software and nr8 composition/editing interface. For every product mentioned above, the user either owns the original content a.k.a. source content or otherwise is in possession of the content. The content is actually stored locally in most cases except for weVideo where the content could be on weVideo cloud servers but they are still ‘owned’ by the content editor. In all of the above cases, the final video itself is stored in a single location as one video. However with NR8 service, the composer does not possess the source content and neither does he possess the edited content. He/she merely defines time-based rules for streaming specific media resources from external streaming services. The final Nr8 itself is just a set of rules, and the content referenced in these rules stream directly from the respective streaming services.

### NR8 Fine Grained Indexing for Search

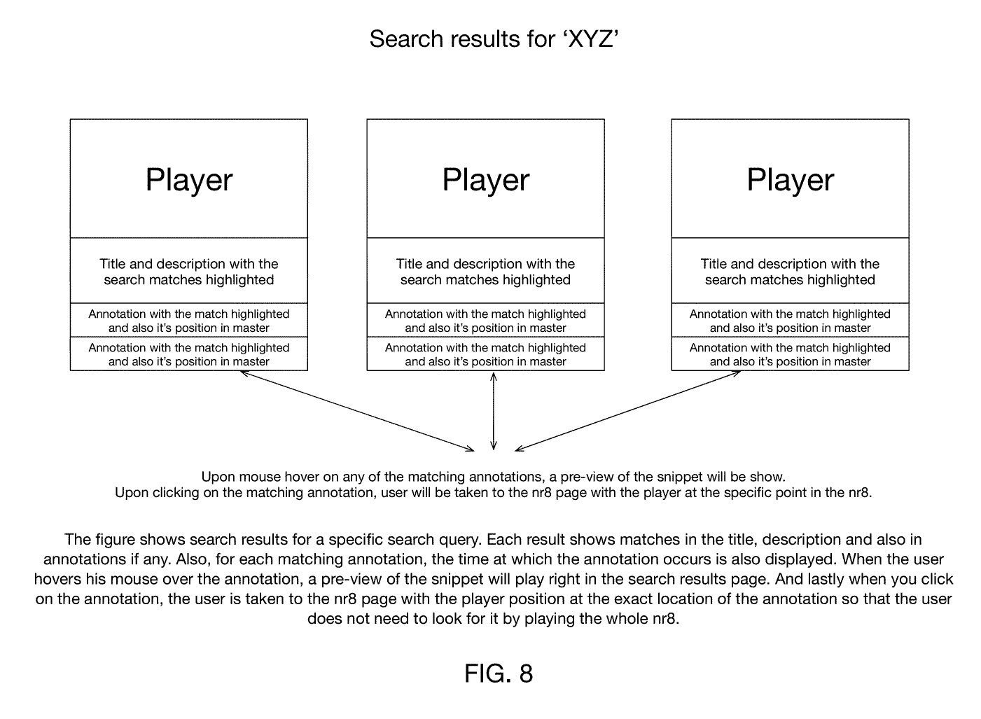

Referring now to FIG. 8, the invention allows for cataloging/indexing of the video content at a finer granularity with text annotations that are tagged to specific time intervals in the nr8 which in turn correspond to specific segments in embedded streaming video. This will allow for a greater search engine efficiency where popular search engines such as Google and bing can match the user queries with relevant annotated text, which in turn lead users to the right video content and more importantly to specific relevant time intervals in those videos.

As described in previous sections and FIG. 3, a NR8 player has a top-panel which streams video and some interspersed textual transitions and a bottom-panel which displays time-synchronized text annotations. While watching a nr8, one can use scroll buttons on the control bar to scroll through different ‘annotation pages’ to scan through the text. As they scroll back and forth, the progress icon for the video on the top jumps to appropriate point in time of the video. Thus one can decide to jump to specific parts of the video instead of having to watch the whole video, based on its annotated text using the scroll buttons. This allows someone to have an added convenience which is not possible with a regular video player.

Turning now to FIG. 8, in one embodiment of the invention, NR8 service provides a search feature on nr8.com that allows users to search for whatever text key words they wish. When a user performs a search query on the NR8 platform which yields one or more results, the users are provided with the ability to preview snippets of specific parts of the video right on the search results page. This is in sharp contrast to how the current video platforms such as YouTube offer the search experience. On these platforms, the search results are often lengthy videos with no clue provided as to where exactly in this long video is the particular aspect that the user is searching for. Hence, these products put the burden on the user to watch the entire video to find the part that is relevant to them, if it is there in the first place.

However with NR8, referring again to FIG. 8, when a user searches for a specific text on the NR8 platform, the search results are listed on a page and as part of each listing all the matching annotation texts along with their position in the master timeline is also displayed. When the user hovers the mouse (and not click) on this matching annotations, a preview of this particular part of the video will be shown right on the search results page. (Please note that, as will explained in the following sections, clicking on the annotation loads the particular nr8 page and takes the user to the specific time in the video where this matching annotations occurs).

This invention provides an ability to quickly preview multiple snippets of the videos with minimal navigation and minimal time spent. This is because the snippets are played right on the search results page and also the snippets comprise of the specific parts of the the videos which are likely relevant to the user based on the search he performed. The search experience described in this invention is significantly more efficient and better suited for video content compared to prior art.h.

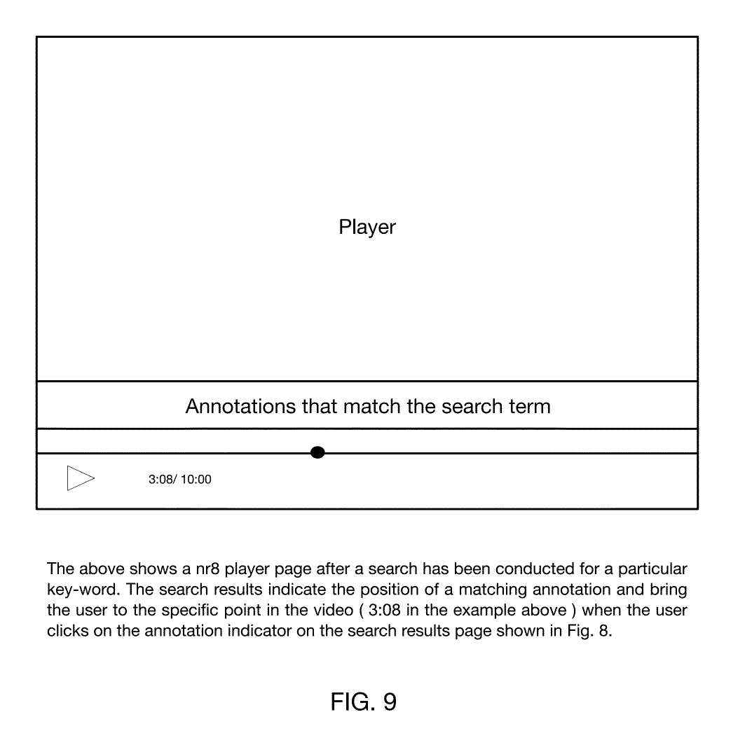

Referring now to FIG. 9, in one embodiment of this invention, when the user performs a search on the NR8 platform and then selects a search result from the results page presented, it takes them to the specific ‘state’ of nr8, which on the bottom panel has annotation page that contains the matching text and on the top panel has the media with progress icon at exactly the corresponding point on the master time-line. Users will also be lead to specific segments of a nr8 directly through queries on popular search engines.

In any embodiment of the invention, the video content is not directly indexed nor are the video's indexed to certain key-frames. What is indexed is text annotations which are stored on Nr8's servers which are mapped to a Nr8 master time-line. This master time-line is in turn mapped to certain streaming media. Thus NR8 service allows indirectly indexing these streaming media.

One advantage of the above technique of indirect indexing of the media is that nr8's can be used to index any of the media streams on media streaming services such as Youtube and Vimeo. The other advantage is that the same streaming media source can be annotated any number of times through different Nr8's.

To state the importance of the above embodiment of the invention: services such as Google have been able to create a great service by cataloging and indexing all the text data it can access. However, much of the actual contents of the video's, including the video's it owns on it's youtube product is invisible to Google and other search engines. The only way video data is cataloged and indexed currently is through cataloging and indexing title text and “tags words” associated with the WHOLE video. Often times title text and “tag” text are far too small to fully represent all the content that is inside the video.

In the above mentioned services such as Google, even if the title text does accurately represent the content in the video in a search results, the users are still faced with the task of having to swift through the entire video in order to find/watch the specific part of the video that is relevant to them. However, Nr8 allows search engines to catalog and index these videos based on much larger text data represented by text annotations. More over the synchronized text and video inside a Nr8 leads users to the specific time in the Nr8 that contains the exact information that they are seeking. This solution could have significant impact.

### Nr8 Embedded Player Through API Services

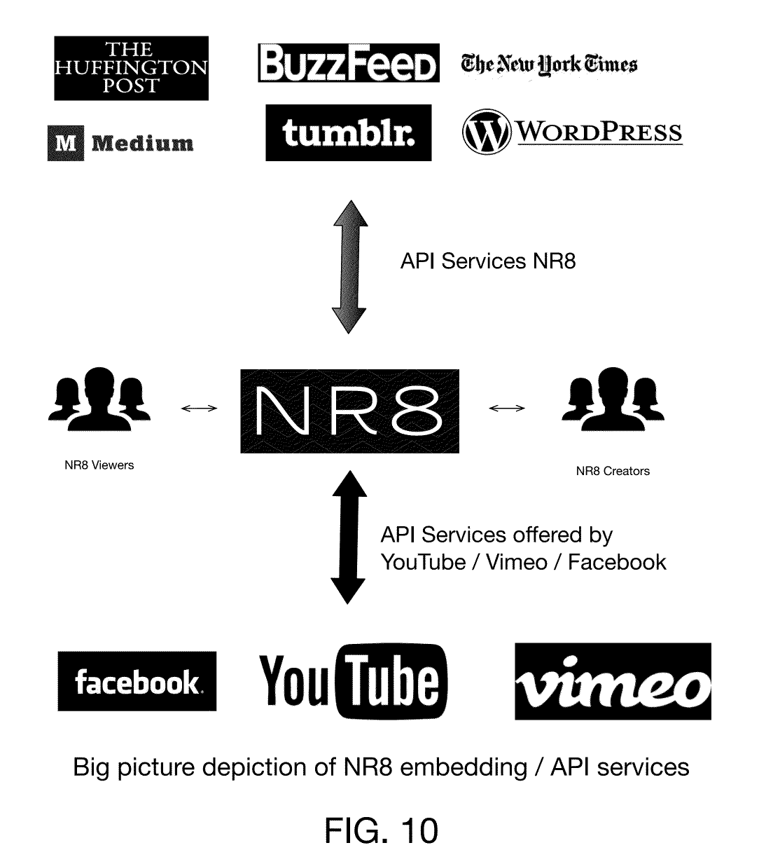

In another embodiment of this invention, referring to FIG. 10, API's are provided so that a nr8 player can be embedded inside another web-page. As can be seen from FIG. 10, NR8 service sits atop the API services from the streaming services such as YouTube, Vimeo and Facebook videos. In turn NR8 service offers it's own API services to other media companies and sites to be able to embed a nr8 in their own pages.

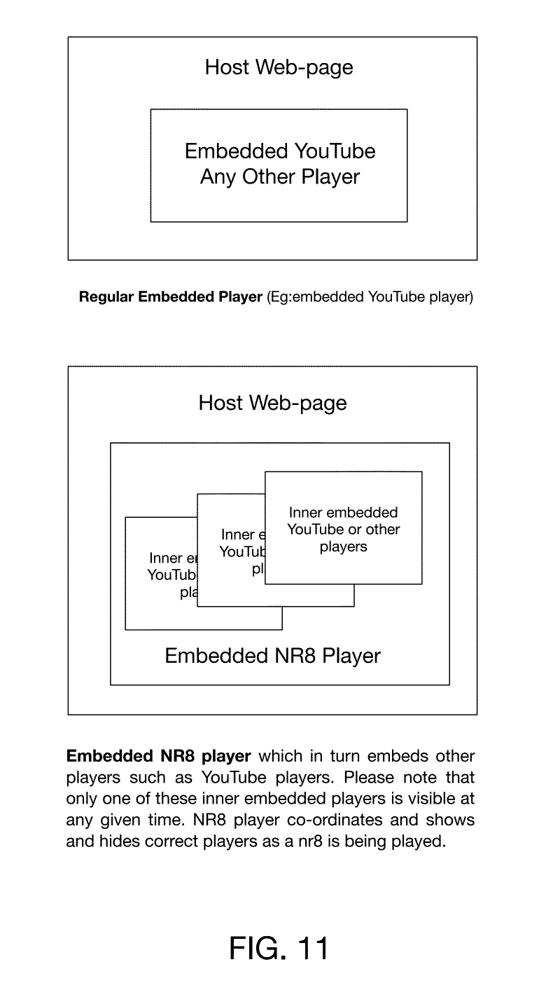

Referring now to FIG. 11, the embedded nr8 player itself will have embedded players from other video services (YouTube, Vimeo etc) within itself. In a nut-shell this is like having embedded players inside of an embedded player on a web-page.

Almost all major news sites such as nytimes.com, cnn.com and also popular blogs, embed video players (YouTube, Vimeo etc) inside their pages. When an external player is embedded in a page, that part of the browser real estate will be totally controller by the service which provides the API. The current invention described here-in provides a similar service where the NR8 player can be embedded in other web-pages just like they embed youtube and Vimeo players. However, the key difference is that the NR8 player itself may contain other embedded players (such as Youtube and Vimeo) inside of it as depicted in the FIG. 11 above. These inner embedded players are controlled (as far as when to start and stop) by the NR8 player but the media content itself streams into the inner embedded players directly from the respective streaming services.

### Side-By-Side Streaming of Time Synchronized Streaming Media

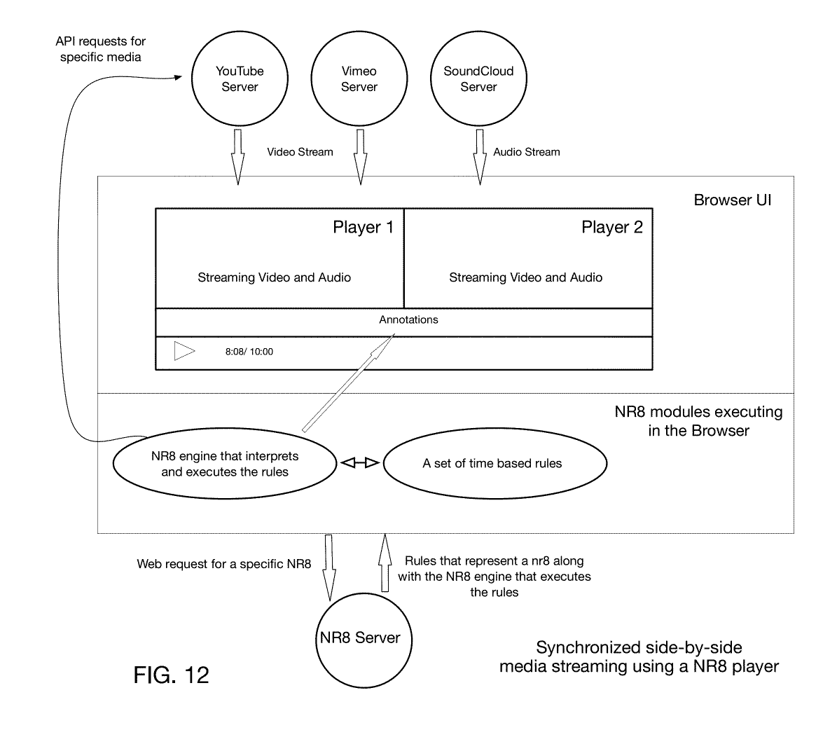

In another embodiment of the invention, referring to FIG. 12, Nr8 player allows creating a Nr8 which supports side-by-side streaming of two (or more) time synchronized streaming media. This aspect of NR8 service is similar to the concept of NR8 service described in previous sections, with the difference being that there are two panels at the top that contain streaming media players. The media streams from these two players are time-synchronized with one another. This is depicted in the FIG. 12. Both of these media streams share a common master time-line, common control bar and also a common botox-panel to display the annotation text. From that stand-point synchronization, it is totally different from two embedded media players placed side by side.

System Block Diagram

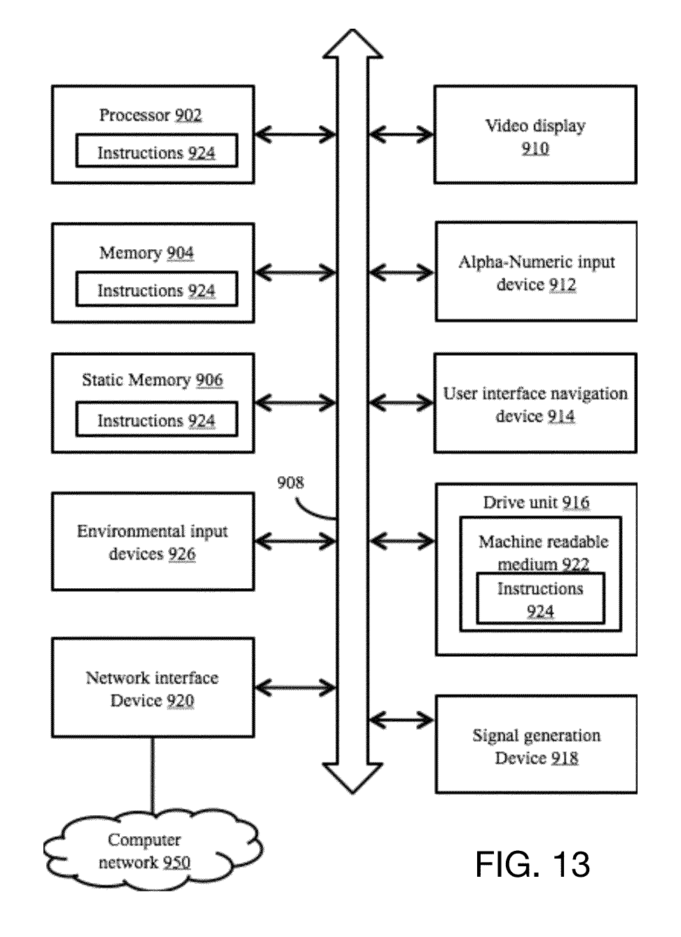

FIG. 13 is a block diagram of a machine in the example form of a computer system 900 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU), or both), a main memory 904, and a static memory 906, which communicate with each other via a bus 908. The computer system 900 may further include a video display unit 910 (e.g., a liquid crystal display (LCD) or a cathode ray tube (CRT)). The computer system 900 also includes an alphanumeric input device 912 (e.g., a keyboard), a user interface (UI) navigation device 914 (e.g., a mouse), a disk drive unit 916, a signal generation device 918(e.g., a speaker), and a network interface device 920. The computer system 900 may also include a environmental input device 926 that may provide a number of inputs describing the environment in which the computer system 900 or another device exists, including, but not limited to, any of a Global Positioning Sensing (GPS) receiver, a temperature sensor, a light sensor, a still photo or video camera, an audio sensor (e.g., a microphone), a velocity sensor, a gyroscope, an accelerometer, and a compass.

### Machine-Readable Medium

The disk drive unit 916 includes a machine-readable medium 922 on which is stored one or more sets of data structures and instructions 924 (e.g., software) embodying or utilized by any one or more of the methodologies or functions described herein. The instructions 924 may also reside, completely or at least partially, within the main memory 904 and/or within the processor 902 during execution thereof by the computer system 900, the main memory 904 and the processor 902 also constituting machine-readable media.

While the machine-readable medium 922 is shown in an example embodiment to be a single medium, the term “machine-readable medium” may include a single medium or multiple media (e.g., a centralized or distributed database, and/or associated caches and servers) that store the one or more instructions 924 or data structures. The term “non-transitory machine-readable medium” shall also be taken to include any tangible medium that is capable of storing, encoding, or carrying instructions for execution by the machine and that cause the machine to perform any one or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non-transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Transmission Medium

The instructions 924 may further be transmitted or received over a computer network 950 using a transmission medium. The instructions 924 may be transmitted using the network interface device 920 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible media to facilitate communication of such software.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans or Enterprise Java Beans. Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 802.11 including its substandards a, b, e, g, h, i, n, et al.). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Any of the embodiments described may be performed by computers, including general purpose computers, connected (to a network or the Internet) computers, or combinations of client-server computers and/or peer-to-peer terminals. In accordance with one deployment, the system may be provisioned as software executing on a server in the cloud wherein a client device such as mobile phones are provisioned with a client application to connect with the system over a network (e.g. the Internet). Provider interface may display content on a website, mobile application, tablet application and/or the like.

It is contemplated for embodiments of the invention to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, USB and other removable media, hard disk drives, optical disks (e.g., Compact Disk Read-Only Memory (CD ROMS), Digital Versatile Disks, (DVDs), etc.), and flash drives, among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense.

Accordingly, the disclosure of the present invention is intended to be illustrative, but not limiting, of the scope of the invention, which is set forth in the following claims.

1. A computer-implemented method for creating a streaming media compilation having time-synchronized annotations, the method comprising:
accessing streaming media from one or more external sources through a browser user interface;
passing a particular nr8 to the requesting browser along with two entities, one of which is a set of rules that make up the nr8 and the second is computer module or engine which knows how to interpret these accompanying set of rules;
NR8 engine that, upon loading a nr8 page, pre-loads and pre-buffers all of the streaming media players (which remain hidden except for the one that needs to be visible at any given point in time) that are part of the said nr8 in order to provide a seamless playback experience at the time of playback.
tagging and annotating the streaming media;
mapping the annotations to a master time-line thereby providing a single seamless video experience of one single media presentation wherein the user performs a desired action, the action includes one of play, pause, seek and scroll; and
displaying a top panel and a bottom panel to a user through a Nr8 user interface.

2. The computer-implemented method of claim 1 wherein playing a particular nr8 in a browser further comprises:
Passing a set of rules which are time-based sequence of actions that represent Nr8 rules which specify exactly when a streaming of a certain media resource should begin and end; These rules represent a nr8 in a master-timeline; and
interpreting and executing the Nr8 rules by a Nr8 engine;
A NR8 engine that pre-loads and pre-buffers all the streaming media players simultaneously at the time nr8 page load, with the necessary ones being hidden and unhidden during playback resulting in a seamless playback.

3. The computer-implemented method of claim 1 wherein composing a nr8 comprising of the streaming media further comprises:
specifying one or more segments in a media stream for streaming;
displaying the segments as an embedded media player;
allowing the user to add annotations into specific portions of the segments; and
storing the nr8 in a database, wherein the nr8 is a set of rules and content, the content is referenced directly from the respective streaming services.

4. The computer-implemented method of claim 1 and further comprising:
allowing the person composing a nr8 to playback and preview the nr8 being composed at any point of time subsequent; and
permitting the user to edit a composed nr8 at a later point of time.

5. The computer-implemented method of claim 1 wherein, the two entities that are passed to a requesting browser which requests for a particular nr8, are a set of time-based rules that constitute the nr8 and a NR8 engine to capture user interactions with the user interface and carries out the set of rules to provide the user with a nr8 experience.

6. The computer-implemented method of claim 1 wherein the top panel includes the embedded streaming video and transitions and the bottom panel includes annotation text and annotation images that are time-synchronized with the top panel.

7. The computer-implemented method of claim 1 and further comprising:
storing a plurality of user created annotations;
storing references to external media resource identifiers (without storing the media itself;
the media remains on the host streaming services such as YouTube and are streamed into the requesting browser during playback) wherein a start time and end time within the media stream are stored along with a mapping to a master time-line; and
storing the text and images used in transitions and annotations locally on the Nr8 server and are subsequently used during a nr8 playback.
the annotations coming in from the nr8 server are time synchronized with the media stream coming in from the host streaming services at the time of playback on the requesting browser' s nr8 player user interface. The synchronization will be facilitated by the nr8 engine.

8. The computer-implemented method of claim 1 and further comprising:
allowing a user to compose a nr8 by embedding external media streams on the NR8 composition page that has similar look and feel as that of a traditional video editing interface however differs drastically in terms of underlying functionality; the primary one being that the media itself is not locally stored but comes directly from external streaming services.
The composition of nr8 involves creating time based rules that comprise of the nr8, with time based references to external steaming media sources.

9. The computer-implemented method of claim 8 wherein composing further comprises:
selecting specific times within the media streams to be a part of the Nr8 using video editing like interface; and
allowing the user to enter annotation text and images with user interface controls that indicate the specific times in the media stream to synchronize the said annotation text and images with the streaming media.

10. The computer-implemented method of claim 1 and further comprising:
indexing nr8's stored on NR8 servers in fine granular fashion based in annotations;
mapping the indexed text annotations to a nr8 master time-line; and
mapping the Nr8 master time-line to specific streaming media.

11. The computer-implemented method of claim 1 and further comprising:
allowing the user to search for specific nr8;
Present a search result where individual results presented indicate matches in nr8 title, description and also annotations,
displaying specific times at which relevant matching annotations occur allowing the user to pre-view snippets corresponding to matching annotations right in the search results page listing
bringing the user to an exact point on a time-line in the corresponding video when he/she clicks on a matching annotation from search results listing page.

12. The computer-implemented method of claim 1 and further comprising:
creating a nr8 that supports side-by-side streaming of at least two time synchronized streaming media, wherein the nr8 includes two streaming media players in the top panel and the usual annotations on the bottom panel.

13. A computer program product stored on a non-transitory computer-readable medium that when executed by a processor, performs a method for creating a streaming media compilation having time-synchronized annotations, the computer program product comprising:
allowing external media sites to embed a nr8 in their pages accessing streaming media from one or more external sources through a browser user interface from this embedded nr8 player;
passing a particular nr8 to requesting browser with to two entities: a set of rules comprising a nr8 and an engine that interest and executes these rules;
displaying a top panel and a bottom panel in this embedded nr8 player;

[symbol]

14. The computer program product of claim 13 wherein passing the particular Nr8 further comprises:
defining a set of rules which are time-based sequence of actions that represent Nr8 rules which specify exactly when a streaming of a certain media resource should begin and end;
interpreting and executing the Nr8 rules by a NR8 engine; and
pre-loading and pre-buffering all the necessary streaming media players simultaneously in order to achieve a seamless playback, with only one of the player being visible at any given time while the others remain hidden until it is time for them to be visible;
representing the Nr8 rules on a master time-line.

15. The computer program product of claim 13 wherein annotating the streaming media further comprises:
specifying one or more segments in a media stream for streaming;
displaying the segments as an embedded media player;
allowing the user to add annotations into specific portions of the segments; and
storing the Nr8 in a database, wherein the nr8 is a set of rules and content, the content is referenced directly from the respective streaming services.

16. The computer program product of claim 13 and further comprising:
allowing the user to play the nr8 at any point of time subsequent to composition; and
permitting the user to edit a composed nr8 at a later point of time.

17. The computer program product of claim 13 wherein the two entities are a set of time-based rules that constitute the nr8 and a NR8 engine to capture user interactions with the user interface and carries out the set of rules to provide the user with a NR8 experience.

18. The computer program product of claim 13 wherein the top panel includes the embedded streaming video and transitions and the bottom panel includes annotation text and annotation images that are time-synchronized with the top panel.

19. The computer program product of claim 13 and further comprising:
storing a plurality of user created annotations;
storing references to external media resource identifiers wherein a start time and end time within the media stream are stored along with a mapping to a master time-line; and
storing the text and images used in transitions and annotations locally on the Nr8 server and are subsequently used during a nr8 playback.

20. The computer program product of claim 13 and further comprising:
allowing a user to compose a nr8 by embedding external media streams on the Nr8 composition page.

21. The computer program product of claim 20 wherein composing further comprises:
selecting specific times within the media streams to be a part of the Nr8; and
allowing the user to enter annotation text and images with user interface controls that indicate the specific times in the media stream to synchronize the said annotation text and images.

22. The computer program product of claim 13 and further comprising:
allowing the user to search for specific annotated pages of the Nr8;
bringing the user to an exact point on a time-line in the corresponding video.

23. The computer program product of claim 13 and further comprising:
indexing text annotations stored on NR8 servers;
mapping the indexed text annotations to a NR8 master time-line; and
mapping the NR8 master time-line to specific streaming media.

24. The computer program product of claim 13 and further comprising:
creating a Nr8 that supports side-by-side streaming of at least two time synchronized streaming media, wherein the Nr8 includes streaming media in the top panel and bottom panel.

25. A system for creating a streaming media compilation having time-synchronized annotations, the system comprising:
a computing device configured with a media player to play videos that are streamed from one or more external servers;
a web browser configured within the computing device to display desired web pages with embedded nr8 players;
a web server for serving nr8 rules/engine to a requesting browser for NR8 playback;
a network to connect the computing device to a web browser;
a processing module configured within the web server and operable to perform:
access streaming media from one or more external sources through a browser user interface;
pass a particular nr8 to two entities to a requesting browser: a set of rules that a nr8 is comprised of and nr8 engine that interprets and executes these accompanying rules;
tag and annotating the streaming media;
map the annotations to a master time-line thereby providing a single seamless video experience of one single media presentation wherein the user performs a desired action, the action includes one of play, pause, seek and scroll; and
display a top panel and a bottom panel to a user through a Nr8 user interface.

26. The system of claim 25 and further comprising:
a Nr8 server to:
receive a request for a specific nr8;
fetch the specific nr8 and pass two entities to the web browser;
hand over nr8 rules and Nr8 engine to the web browser; and
store text and images used in transitions and annotations;
a Nr8 engine configured within the nr8 server to interpret and execute the rules; and
a Nr8 user interface to display a top panel and a bottom panel;
a Nr8 composition user interface to create a nr8 experience for a user of the computing device.

27. The system of claim 25 wherein the web server further comprises:
a search engine to search for retrieving specific annotation pages of a matching Nr8.

28. The system of claim 25 and further comprising:
a timer to wake up at specific intervals to look out for specific actions to be carried out as specified by the nr8 rules;
a database to store the composed Nr8;
a NR8 player embedded inside another web page; and
a web browser user interface.

29. The system of claim 25 and further comprising:
a local server to store:
user created annotations and references to external media resource identifiers; and
start and end times within a media stream.
